(19) United States
(12) Patent Application Publication
(10) Pub. No.: US 2009/0199445 A1
(43) Pub. Date: Aug. 13, 2009

(54) Poster or display board with graphics

(75) Inventors: Timothy P. Blaeser, Cary, NC (US); Vincent A. Blaeser, Dublin, OH (US)

Correspondence Address: Joseph G. Nauman, 696 Renolda Woods Ct., Dayton, OH, 45429-3415, US

(73) Assignee: Magware, LLC, CENTTERVILLE, OH (US)

(21) Appl. No.: 12/009,061

(22) Filed: Jan. 16, 2008

Related U.S. Application Data
(60) Provisional application No. 60/880,549, filed on Jan. 16, 2007.

(51) Int. Cl. G09F 7/04; B05D 5/12

(52) U.S. Cl. 40/600; 427/127; 428/99

(57) ABSTRACT

A display board, for personal or business use, capable of receiving and at least temporarily retaining information such as various reminders or memorabilia, The board is comprised of at least two members. A display member, including a ferro-magnetic plate, has a front and back surface, and a graphic image is created (e.g. formed on or attached to) on a predetermined area of said front surface. A transparent protective coating is created over at least selected areas of the graphic image, so as to make such selected areas susceptible to markings thereon or temporary attachment thereto. The markings are temporary, and are of either dry-erase or wet-erase types; they may include such information as reminders and temporary notations for a user, and items such as keys, note cards, etc. may be temporarily held to such ares of the graphic image. At least one magnetic mounting member, such as a plate or one or more permanent magnets, which are attachable to a support area such as a wall or panel, and are capable of attracting & holding a sufficient area of said back surface of the display member so as to maintain the display member firmly against the support area, yet readily detachable therefrom for purposes of replacement, repair, re-location, or updating.

### PRIORITY CLAIM

This application claims priority of Provisional U.S. Application Ser. No. 60/880,549 filed 16 Jan. 2007, the entire contents of which are incorporated by reference herein.

### FIELD OF THE INVENTION

This invention relates to designs of display boards and/or poster boards which (if desired) can be customized to specifications of a user, which presents a unique, and personalized if desired, graphic panel.

### SUMMARY OF THE INVENTION

The board embodies two cooperating assemblies, a display assembly and a mounting assembly. The display assembly comprises a flexible sheet or laminate material, such as moderately flexible Lexan™ sheet, providing an exterior protective transparent layer of predetermined dimensions. A suitable graphic image is formed (for example by known photographic methods) on a thin sheet of photographic film or paper, or (preferably) on a photographic emulsion affixed to a thin sheet of ferro-magnetic material, e.g. thin sheet steel. Once the graphic image is fixed, the exterior protective material can be laminated to most (preferably all) of the area of the film and the graphic information (image) is highly visible with excellent definition through the exterior protective sheet. The result is a thin but substantially rigid assembly showing unique graphics that provides the visually interactive display.

One form of mounting assembly comprises a thin but substantially rigid support or backing panel made from an expanded PVC or an equivalent rigid substrate with a permanent magnetic material laminated to face with pressure sensitive adhesive or material. The rigid support panel is generally of the same width and height dimensions as the graphics panel and its exterior transparent and protective cover sheet, and all three are laminated or otherwise secured together over a substantial portion (or all) of their adjacent surfaces to form a composite display assembly with unique integral graphics. It should be noted that, in many applications of the invention, the aforementioned support panel can be eliminated and other mounting arrangements may be used, such as described below.

The composite display member can be designed to attach to the mounting structure. That mounting assembly structure comprises a frontal attachment panel of permanent magnet material (or equivalent) that preferably is permanently attached to a substantially rigid back panel made of a suitable resinous material or of a pressed particulate material (e.g. thin ‘particle board’). The mounting assembly preferably has suitable chamfered holes for receiving screw heads that can be used to secure the mounting assembly structure on a wall or other surface located. conveniently for the user(s). In one preferred embodiment, the mounting structure panels are slightly shorter (in height and/or width) than the composite display member for purposes of having a “shadow design” feature around the display assembly, and also for providing a convenient peripheral grip when placing, adjusting, or removing the display assembly.

In a simplified arrangement of the mounting assembly, a plurality of permanent magnetic assemblies (commercially available) of a size and power (strength) of magnetic attraction such that a plurality of such members can be attached to a mounting surface (a wall or the like) with appropriate relatively thin magnet members sufficiently spaced apart relation to attract and hold the display assembly and keep it properly aligned and close to the mounting surface,

Thus, in either mounting arrangement, when the finished and assembled display board is mounted there is no visible hardware. The graphics assembly is easily aligned and mounted on, yet removably but firmly secured to, to a desired surface by magnetic attraction force applied to a substantial area of the rear of the rigid graphic assembly. In this simplified arrangement, by positioning the magnets sufficiently inward of the graphic assembly border. The result is easily achieved precise alignment of the graphic assembly.

Therefore, the graphic display member with its protective exterior transparent layer can be only a fraction of an inch from the wall or other surface on which the unit is mounted. Also, precise alignment of the graphic assembly can be easily and quickly achieved. It is easy to level and/or adjust the graphics, vertically and/or horizontally, by simply pulling it away from the magnetic mounting structure and re-attaching it, or replacing it with another, at the desired position.

A further feature of the of the finished display board is its ability to accommodate a large variety of markings, permanent or temporary, such as calendar grids onto which magnetic tabs or other pieces (or erasable marks) can be temporarily attached, a post-it note section into which separate notes can be secured by small magnets, areas into which smaller graphic sheets (such as snap-shots) can be temporarily attached, a surface with spaces on which messages and/or notes can be written and later erased, and so on.

The major graphic on a set of the display boards can each also show a family member (e.g. to be featured during the month in which that member's birthday occurs), or a seasonal set of the display boards on which the major graphic is related to certain holidays or seasons of the year. The possibilities for unique utilization of the novel display board are almost boundless.

### BRIEF DESCRIPTION OF THE DRAWINGS

FIG. 1 is a pictorial view of one embodiment of a display or poster board as provided by the invention, mounted on a wall adjacent a work station;

FIG. 2 is a schematic pictorial view of the components of the graphics assembly itself;

FIG. 3 is pictorial view similar to FIG. 3, illustrating the components of the mounting assembly;

FIG. 4 is a partial perspective view of a corner portion of the mounting plate structure.

FIG. 5 is a pictorial view of a display board being fitted to and mounted on the mounting assembly;

FIG. 6 is an enlarged partial view of a display assembly showing the attachment (posting) of reminder items onto the display assembly with small magnets;

FIG. 7 illustrates the placing on written reminder items on the display board;

FIG. 8 illustrates removal (as by wiping) of reminders written on the display board;

FIG. 9 is a view of a number of attachment magnets that are preferred for use with the display board;

FIG. 10 is a front view of a document holder accessory for use with the display board;

FIG. 11 is a perspective view of the document holder accessory;

### DESCRIPTION OF PREFERRED EMBODIMENTS

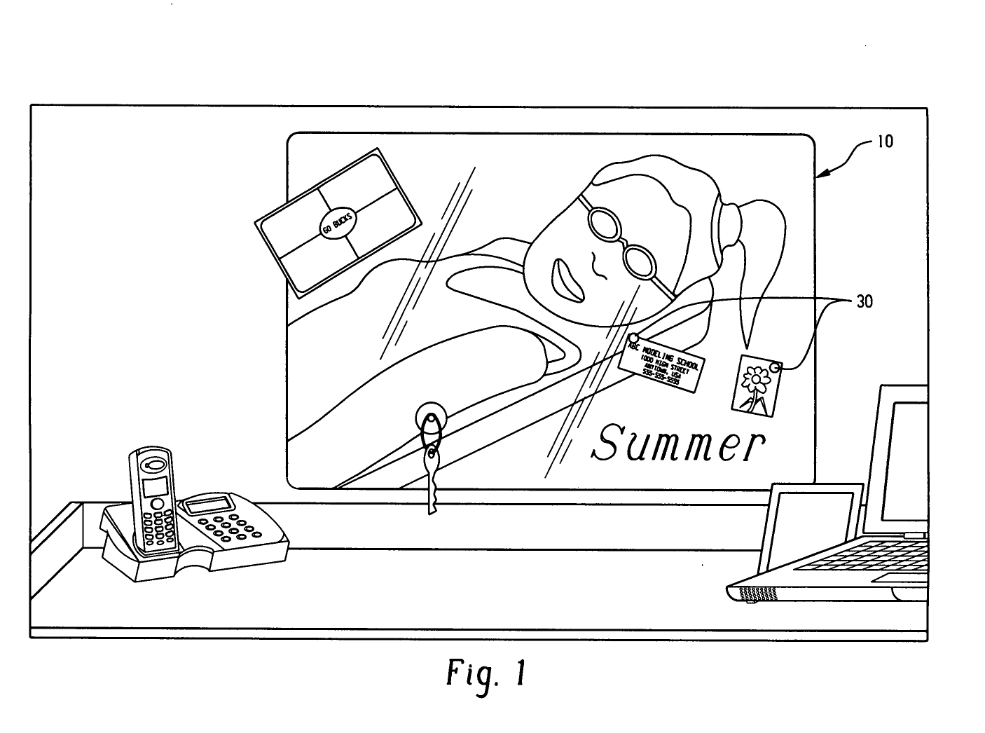

FIG. 1 illustrates a typical embodiment of a display or poster board as provided by the invention, mounted on a wall adjacent a work station which includes a computer, a portable telephone, and a cell phone (by way of example only).

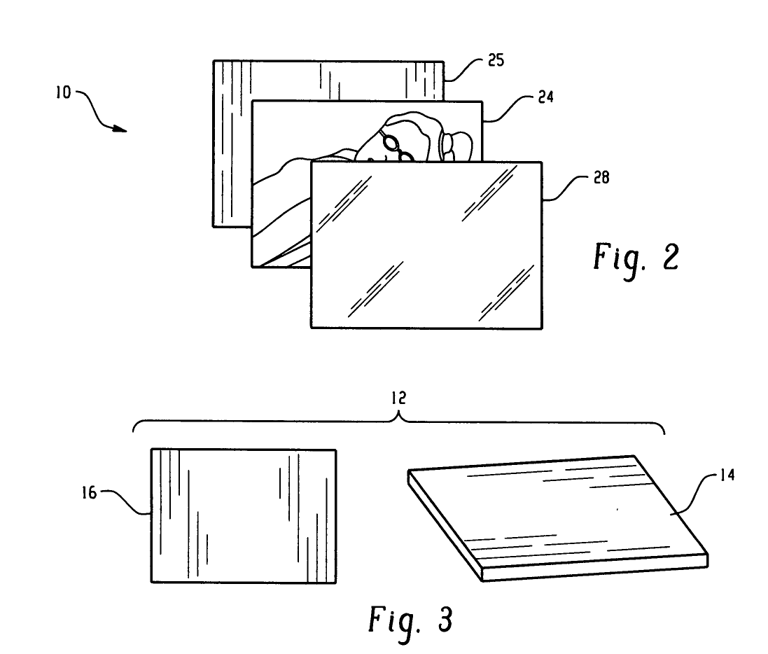

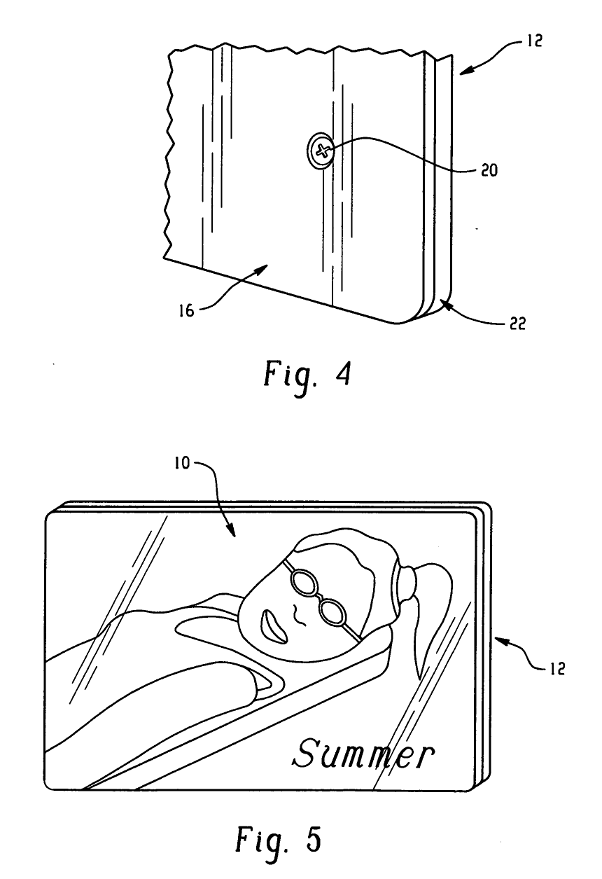

The display assembly 10 (shown in FIGS. 1 & 3) provides unique graphic and useful information, which may be customized, is supported on a mounting assembly 12 (shown in FIG. 2).

The mounting assembly includes a rear or back member 14 that faces the wall or other chosen location for the units. The base or back material for mounting assembly 14 is (for example) expanded PVC or an equivalent other rigid substrate. The forward facing panel of member 14 has a sheet 16 of permanent magnet material laminated thereto with pressure-sensitive material or adhesive, with the magnetic surface 18 facing outward. Thus member 14 and sheet 16 provide a rigid, flat, and relatively thin mounting that is designed to contact most (e.g. the majority) of the back surface of display board 10.

Pre-drilled holes 20 (preferably with a countersink) for mounting screws, are strategically placed around the mounting plate assembly, usually at the corners, with countersunk holes 18 able to position screw heads below the back side of the magnetic surface; this has been found to improve the retaining power of the magnetic mounting. The mounting assembly structure may be provided with rounded corners 22 for safety and improved appearance

In a preferred embodiment of the invention the mounting assembly is sized at least one-half inch smaller in length and/or width than the display assembly 10. This provides room to adjust the display assembly 10 if the horizontal edges of mounting assembly 14 are not perfectly level; this slight reduction in perimeter dimensions of the structure 14 also provides a “finger-lift” edge to ease removal of display assembly 10.

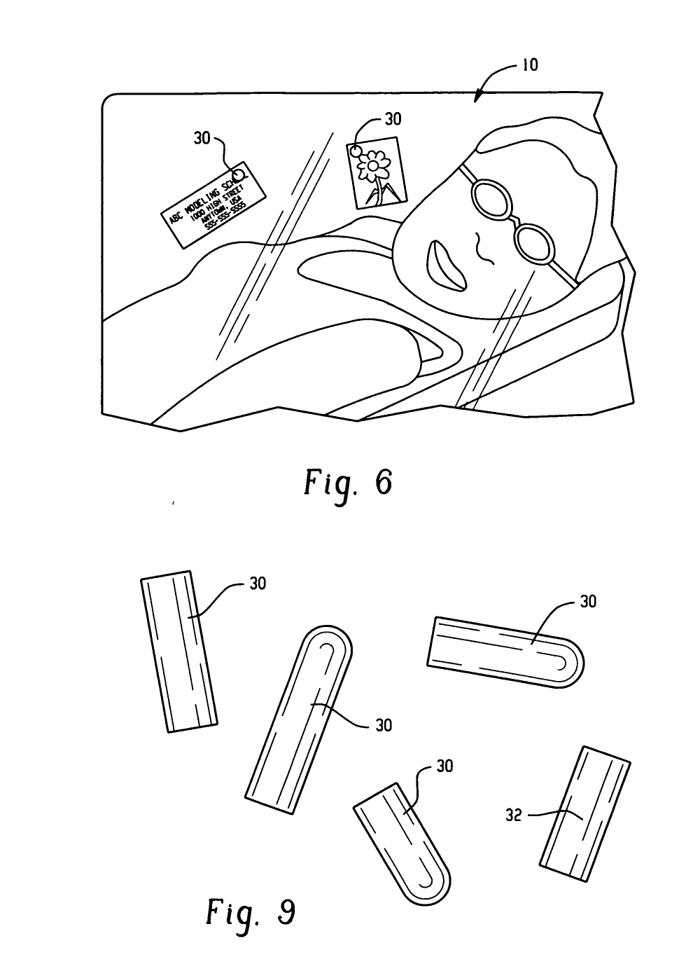

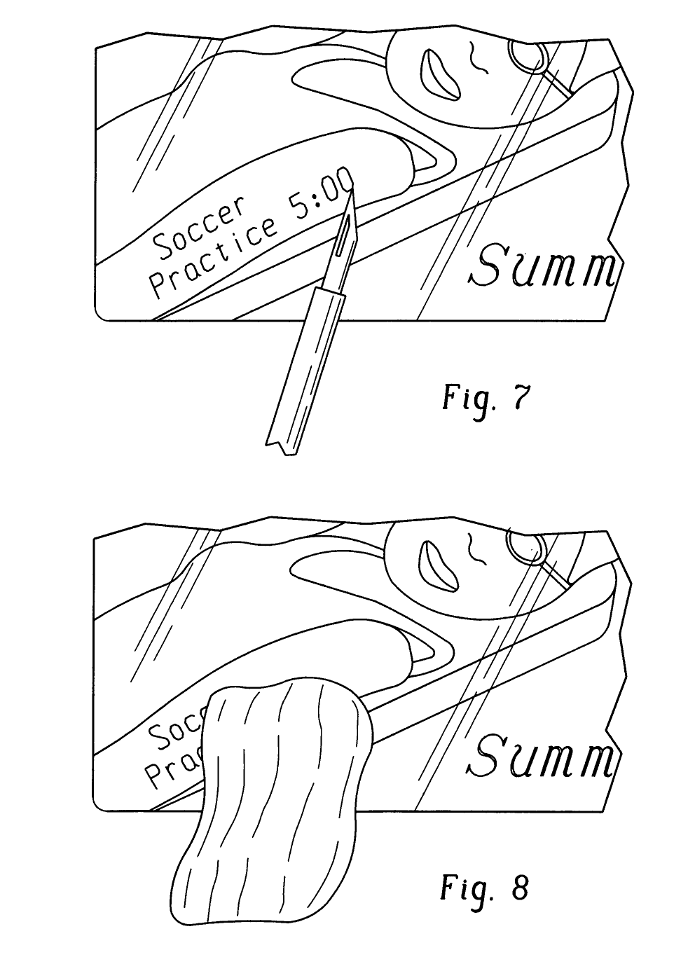

Lamination of the graphics layer and image 24 to the magnetic (ferrous content) steel plate 25 adds rigidity to display assembly 10 and adding the transparent hard & scratch-resistant outer layer 28 (exterior front surface) substantially enhances the durability of the graphics images which are protected by a durable transparent film. Such a combination of rigidity and hard surfaced top laminate allows notes or messages or other images to be written on the exterior of the display assembly 10 with either wet-erase or dry-erase markers, and later erased/removed (see FIGS. 5 and 6). Wet-erase ink will dry quickly, does not easily rub off, and yet removes completely & easily with a damp cloth. It is also possible to form the image on a surface of an appropriate and relatively thin ferro-magnetic plate that is coated with a photosensitive emulsion onto which an image can be formed & developed.

This novel combination of features eliminates need for a frame, glass, or conventional framing materials. Additionally small colored partial tubes surrounding permanent magnets 30, 32 and/or magnetic accessories can now attach to the frontal surface of the graphics member 10 (see FIGS. 1 and 6), as either an indicator or to “attach” a note, small photograph, or another small item. The various colors of tubes 30 can be employed to indicate different meanings.

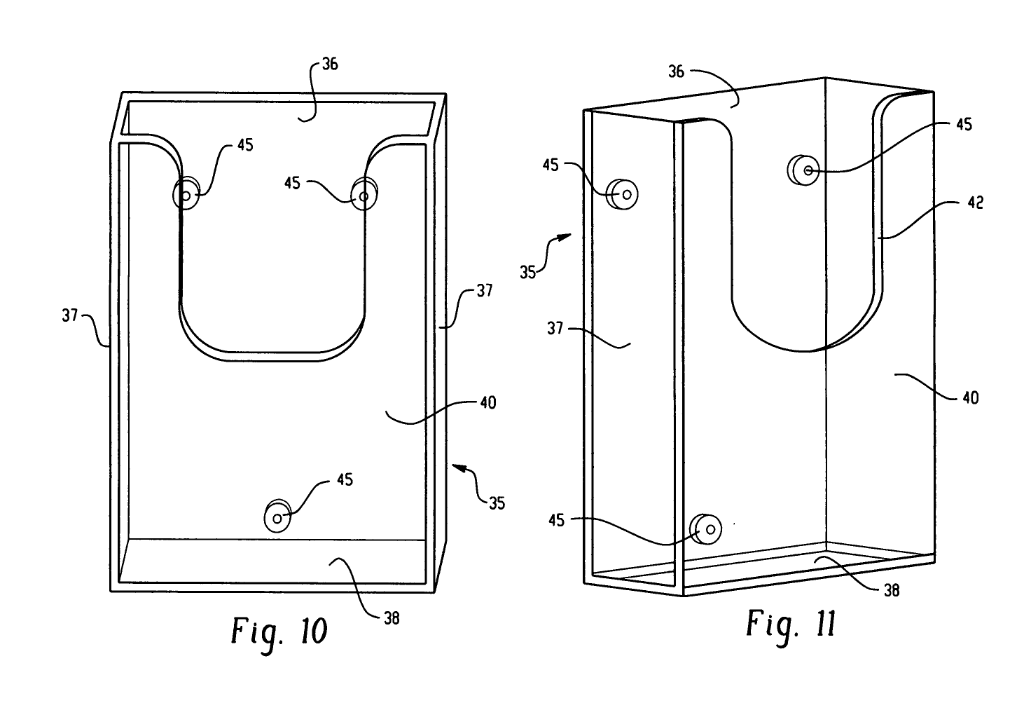

FIGS. 10 and 11 illustrate a commercially available document holder that is modified to adapt it for magnetic attachment to the display board as an optional accessory. The holder 35 is constructed of transparent acrylic and includes a back 36, sides 37, a bottom 38, and a front 40 with and access opening 42 through which a document of pamphlet may be grasped to allow its withdrawal through the open top of the holder. A quantity of “give away” documents can be stored on the display board for dispersal to interested parties, or the holder can be available as a personal temporary storage place for various items.

An array of permanent magnets 45 are secured to the rear outside of holder wall 36 to provide a means for securing the holder in a convenient place on the display board. In a typical embodiment of the holder, the magnets 45 are disk-shaped neodymium magnets, which are capable of creating a strong magnet circuit with the thin steel plate 25 within the display assembly 10.

Referring to FIGS. 12 and 13, it is also possible to create a mounting assembly by attaching (FIG. 12) a plurality of larger magnet devices 50 in properly selected spaced relation, directly on a wall surface 52. For example, a permanent magnetic assembly 55 (FIG. 13) with a shallow cup-shaped housing 56 (as of steel) surrounds magnet 55 and has a central aperture 58 which can receive an appropriate screw or comparable fastener (not shown). It is preferred that the magnets be spaced from each other within an area of the wall surface 52 which is substantially less in width and height that the area defined by the graphics assembly border. This spacing allows precise vertical and/or horizontal alignment adjustment of the graphics assembly without a need to move the magnets.

While the method(s) herein described, and the form(s) of apparatus for carrying this (these) method(s) into effect, constitute preferred embodiments of this invention, it is to be understood that the invention is not limited to this (these) precise method(s) and form(s) of apparatus, and that changes may be made in either without departing from the scope of the invention.

What is claimed is:

1. A customizable display board capable of receiving and at least temporarily retaining information, comprising
a display member including a ferro-magnetic plate having a front and back surface,
a graphic image on a predetermined area of said front surface,
a transparent protective coating over at least selected areas of said graphic image to make such selected areas susceptible to markings thereon such as reminders and temporary notations for a user, and
at least one magnetic mounting member attachable to a support area and capable of attracting sufficient area of said back surface such as to maintain the display member firmly and removably against the support area.

2. A customizable display board as defined in claim 1, wherein said graphic image is photographically developed directly on said front surface of said display board.

3. A customizable display board as defined in claim 1, wherein said graphic image is formed and developed on an intermediate flexible sheet, and said sheet is laminated to said front surface of said display board with such image facing outward of said front surface of said display board.

4. A customizable display board as defined in claim 2, wherein said graphic image includes interactive areas such as calendar designs, and magnetic marking pieces are provided to be temporarily attached to said interactive areas as reminders.

5. A customizable display board as defined in claim 3, wherein said graphic image includes interactive areas such as calendar designs, and magnetic marking pieces are provided to be temporarily attached to said interactive areas as reminders.

6. A customizable display board as defined in claim 3, wherein said graphic image includes interactive coated surface areas, such as calendar designs and memo locations, for accepting erasable markings to be temporarily made on said interactive areas.

7. A customizable display board as defined in claim 1, wherein said magnetic mounting member comprises a plurality of discrete thin permanent magnet members attachable selectively to a support surface such as to engage said back surface of said display board in a distributed manner sufficient to secure a substantial area of said back surface to a support surface.

8. A customizable display board as defined in claim 1, wherein said magnetic mounting member comprises a discrete thin unitary permanent magnet member attachable selectively to a predetermined area of a support surface such as to engage a substantially continuous area of said back surface of said display board and to provide a releasable mounting for said display board to said support surface.

9. The method of making a customizable display board capable of receiving and at least temporarily retaining information, comprising
a) providing a display member including a ferro-magnetic plate having a front and back surface,
b) creating a graphic image on a predetermined area of said front surface,
c) placing a transparent protective coating over at least selected areas of said graphic image to make such selected areas susceptible to markings thereon such as reminders and temporary notations for a user, and
d) providing at least one magnetic mounting member attachable to a support area and capable of attracting sufficient area of said back surface such as to maintain the display member firmly and removably against the support area.
